(19) United States
(12) Patent Application Publication
(10) Pub. No.: US 2026/0321978 A1
(43) Pub. Date: Oct. 15, 2026

(54) SELF-POWERED WIRELESS SENSING AND COMMUNICATION DEVICE BASED ON RADIO FREQUENCY ENERGY HARVESTING

(71) Applicant: BEIJING INSTITUTE OF TECHNOLOGY, Beijing (CN)

(72) Inventors: Hailing FU, Beijing (CN); Ruizhe HOU, Beijing (CN); Fang DENG, Beijing (CN); Xingwang ZHOU, Beijing (CN); Haopeng XIE, Beijing (CN); Ning DING, Beijing (CN); Xiangyang WANG, Beijing (CN); Maobin LV, Beijing (CN); Jiadong ZHOU, Beijing (CN)

(73) Assignee: BEIJING INSTITUTE OF TECHNOLOGY, Beijing (CN)

(21) Appl. No.: 19/642,716

(22) Filed: Apr. 9, 2026

(30) Foreign Application Priority Data
Apr. 11, 2025 (CN) 202510451640.2

(51) Int. Cl. H01Q 9/04; H01Q 1/52; H01Q 5/10; H02J 50/00

(52) U.S. Cl. CPC H01Q 9/0414; H01Q 1/521; H01Q 5/10; H02J 50/001

(57) ABSTRACT

Provided is a self-powered wireless sensing and communication device based on radio frequency energy harvesting. An upper-layer antenna of the double-layer microstrip patch antenna forms a top surface of a housing; four side surfaces of the housing are all formed by the dual-frequency microstrip patch antennas and are fixedly connected to a periphery of the upper-layer antenna. An antenna support frame forms a bottom surface of the housing and is slidably constrained within the housing. A transition circuit is configured to integrate harvested radio frequency energy to a radio frequency rectifier circuit. The radio frequency rectifier circuit is configured to convert the radio frequency energy into direct current. An energy storage device is configured to store electrical energy and supply the electrical energy to a control module.

### CROSS REFERENCE TO THE RELATED APPLICATIONS

This application is based upon and claims priority to Chinese Patent Application No. 202510451640.2, filed on Apr. 11, 2025, the entire contents of which are incorporated herein by reference.

### TECHNICAL FIELD

The present disclosure relates to the technical field of the Internet of Things (IoT), and in particular, to a self-powered wireless sensing and communication device based on radio frequency (RF) energy harvesting.

### BACKGROUND

With the continuous development of IoT technologies, the demand for wireless sensor networks (WSN) in fields such as smart homes, smart factories, and intelligent transportation is increasing day by day. While IoT devices are widely used, they also face significant challenges in terms of energy supply. Traditional wireless sensors usually rely on a battery power supply, which not only increases maintenance costs, but also restricts the long-term use of devices and environmental sustainability. Therefore, the development of wireless intelligent sensing devices with self-powered functions has become a research hotspot, and RF energy harvesting technology is an ideal solution.

RF energy harvesting technology harvests RF energy in the environment (such as Wi-Fi, Bluetooth, and mobile communication signals) and converts the RF energy into direct current, thereby providing energy for low-power devices. However, existing RF energy harvesting devices mostly rely on single functional modules and have the limitation that energy harvesting is independent of sensing and communication functions.

In terms of sensing technologies, the patch antenna itself can serve as a sensor with high integration and miniaturization characteristics, and has broad application prospects in the field of IoT. Patch antennas can not only effectively harvest RF signals but also act as sensors to monitor environmental changes, especially sense changes in physical quantities such as temperature, humidity, gas concentration, vibration displacement, and stress-strain through changes in the antenna resonant frequency. Since the resonant frequency of the patch antenna is sensitive to environmental changes, it has unique advantages in wireless sensing.

However, current research on combining RF energy harvesting and sensing functions into the same antenna system is not yet thorough enough. Particularly, how to achieve multi-functional integration of the patch antenna to simultaneously undertake the tasks of energy harvesting, environmental sensing, and information communication remains a technical challenge. Most existing technologies focus on either RF energy harvesting or a single sensing function, and especially in the unified design of physical structure and functional modules, high integration and high efficiency have not yet been achieved.

### SUMMARY

The present disclosure provides a self-powered wireless sensing and communication device based on RF energy harvesting. The self-powered wireless sensing and communication device can efficiently and omnidirectionally harvest RF energy through dual-frequency microstrip patch antennas and double-layer microstrip patch antennas, monitor changes in physical quantities in the environment, and achieve the integration of RF energy harvesting and wireless communication by means of time division multiplexing.

To achieve the above objective, the present disclosure adopts the following specific technical solutions:

A self-powered wireless sensing and communication device based on RF energy harvesting is provided, including a housing, dual-frequency microstrip patch antennas, a double-layer microstrip patch antenna, an antenna support frame, a transition circuit, an RF switch, an RF rectifier circuit, an energy storage device, and a control module.

The housing is a hollow cubic structure; the double-layer microstrip patch antenna includes an upper-layer antenna and a lower-layer antenna, where the upper-layer antenna and the lower-layer antenna are completely separated, have an air gap, and are configured to achieve functions of the RF energy harvesting and sensing; the upper-layer antenna forms a top surface of the housing; the lower-layer antenna is supported at a bottom end of the upper-layer antenna through the antenna support frame; four side surfaces of the housing are all formed by the dual-frequency microstrip patch antennas and are fixedly connected to a periphery of the upper-layer antenna; the antenna support frame forms a bottom surface of the housing and is slidably constrained between the four side surfaces of the housing in a vertical direction for adjusting a height of the air gap; the dual-frequency microstrip patch antennas are configured to achieve functions of the RF energy harvesting and wireless communication; the lower-layer antenna and the dual-frequency microstrip patch antennas are all coaxially fed using a back-feeding method and are connected to the RF rectifier circuit.

The transition circuit, the RF switch, the RF rectifier circuit, the energy storage device, and the control module are all located inside the housing and are fixedly installed on the antenna support frame; the transition circuit is configured to integrate RF energy harvested by the double-layer microstrip patch antenna and the dual-frequency microstrip patch antennas into the RF rectifier circuit; the RF rectifier circuit is configured to convert the RF energy into direct current; the energy storage device is configured to store electrical energy converted by the RF rectifier circuit and supply the electrical energy to the control module to achieve self-powered operation; and the control module is configured to control the RF switch to achieve function switching of the dual-frequency microstrip patch antennas, enabling the RF energy harvesting and the wireless communication in different time periods.

Further, the dual-frequency microstrip patch antennas each include a radiation patch, a first dielectric substrate, a first metal ground layer, and a first coaxial probe feed structure; the radiation patch is formed on an outer side surface of the first dielectric substrate; the first metal ground layer is formed on an inner side surface of the first dielectric substrate; the first coaxial probe feed structure is formed by a SubMiniature version A (SMA) connector welded into first coaxial feed through-holes of the radiation patch, the first metal ground layer, and the first dielectric substrate, and the first coaxial probe feed structure is configured to achieve resonance in different frequency bands, such that the dual-frequency microstrip patch antennas operate in dual frequency bands.

Further, the radiation patch and the first metal ground layer are formed on the first dielectric substrate by deposition using metallic copper; the radiation patch is subjected to anti-oxidation treatment by tin plating; a solder mask layer for increasing isolation is provided on an inner surface of the first metal ground layer; the radiation patch and the first metal ground layer are rectangular, and a length and a width of the radiation patch are smaller than a length and a width of the first dielectric substrate respectively; the first metal ground layer covers the inner side surface of the first dielectric substrate; and the first dielectric substrate is made of a high-strength insulating material.

Further, the upper-layer antenna is a parasitic patch antenna; and the lower-layer antenna is a main patch antenna.

The parasitic patch antenna is fed by electromagnetic coupling.

Further, the parasitic patch antenna includes a second dielectric substrate and a parasitic patch formed on a top surface of the second dielectric substrate.

The parasitic patch serves as a parasitic coupling unit to increase a bandwidth of the double-layer microstrip patch antenna through the electromagnetic coupling and improve overall radiation efficiency of the parasitic patch antenna; and the parasitic patch is rectangular or circular.

Further, the main patch antenna includes a main radiation patch, a third dielectric substrate, a second metal ground layer, and a second coaxial probe feed structure, where
the main radiation patch is formed on a top surface of the third dielectric substrate;
the second metal ground layer is formed on a bottom surface of the third dielectric substrate;
the second coaxial probe feed structure is fixedly installed on the main radiation patch, the third dielectric substrate, and the second metal ground layer; and
after the main patch antenna is electromagnetically excited, an induced electromagnetic field excites a surface current to generate resonance.

Further, when the double-layer microstrip patch antenna is used as a sensor, a change in a physical quantity in an environment causes a change in the height of the air gap and a change in an antenna resonant frequency, leading to a change in efficiency of the RF rectifier circuit, and enabling monitoring of the physical quantity in the environment.

Further, the antenna support frame includes a bottom plate and four support columns, and the antenna support frame is made of a smooth and insulating material with a low dielectric constant; the bottom plate forms the bottom surface of the housing, and the bottom plate is slidably constrained between four dual-frequency microstrip patch antennas in the vertical direction; and each of the four support columns has a bottom end fixedly installed on a top surface of the bottom plate, and a top end supported on a bottom surface of the lower-layer antenna.

Further, the transition circuit is a 4:1 power divider connected by equal-length coaxial lines, and the transition circuit has four first input ports and one first output port; the four first input ports are respectively connected to the dual-frequency microstrip patch antennas, and the four first output ports are connected to the RF switch; and
the RF switch has one second input port and two second output ports; the second input port is connected to an output terminal of the transition circuit, one of the two second output ports is connected to the RF rectifier circuit, and the other of the two second output ports is connected to the control module.

Further, the RF rectifier circuit includes an impedance matching circuit and a voltage multiplier rectifier circuit,
the energy storage device is a supercapacitor;
the control module samples a direct current output voltage of the RF rectifier circuit, calculates rectification efficiency, and transmits information to the dual-frequency microstrip patch antennas after data encoding; and
the control module controls the RF switch in a time-division multiplexing manner, to switch between the RF energy harvesting and the wireless communication.

Compared with the prior art, the technical solutions of the present disclosure have the following advantages:
1. The self-powered wireless sensing and communication device of the present disclosure is based on the RF energy harvesting technology, and antennas are arranged in the X, Y, and Z directions respectively, so as to omnidirectionally harvest RF energy of different frequency bands widely existing in free space, improve the harvesting efficiency and availability of RF energy, provide power support for the control module and the antennas, and reduce the maintenance cost of wireless sensing nodes and the demand for battery replacement, thereby achieving self-powered operation of the sensing nodes.
2. The double-layer microstrip patch antenna on the top of the housing expands the bandwidth and improves the antenna gain on the basis of a traditional microstrip patch antenna. The double-layer microstrip patch antenna is divided into an upper layer and a lower layer. The upper-layer antenna is a parasitic patch antenna, and the lower-layer antenna is a main patch antenna. When the parasitic patch antenna is placed above the main patch antenna, an induced current is excited on the parasitic patch due to the coupling of electromagnetic fields, forming a new resonance mode. This is equivalent to connecting a plurality of resonance circuits in parallel in an equivalent circuit model of the antenna, thereby expanding the working bandwidth of the antenna. The existence of the parasitic patch increases the radiation surface area, enlarges the equivalent aperture of the antenna, and improves the gain. Meanwhile, the existence of the air gap effectively reduces dielectric loss, improves radiation efficiency, and further improves the antenna gain. The above parasitic patch coupling design reduces physical connections, can flexibly adjust the height of the air gap, and avoids problems such as poor contact and abrasion that may occur in the traditional coaxial feeding mode. Therefore, the design of the double-layer microstrip patch antenna can enhance the harvesting effect of RF energy in the corresponding frequency band.
3. The double-layer microstrip patch antenna on the top of the housing can work as a sensor while harvesting RF energy. When the whole device is placed on a monitored object, changes of physical quantities in the environment (such as pressure, stress-strain, and vibration displacement) are transmitted to the bottom of the device (that is, the bottom plate of the antenna support frame), which will change the height of the air gap between the upper and lower layers of the double-layer microstrip patch antenna, resulting in changes in the antenna resonant frequency, thereby affecting the rectification efficiency of the whole device. Changes of corresponding physical quantities can be inferred by recording and monitoring changes of the rectification efficiency without additional independent sensors, which reduces the device volume and achieves a highly integrated sensing function.
4. The four dual-frequency microstrip patch antennas arranged on the side surfaces of the housing can achieve RF energy harvesting and wireless communication at the same time. By finding an appropriate feed point on the single-layer patch, the antenna can operate in two frequency ranges, improving the harvesting efficiency of RF energy. Meanwhile, the RF switch is controlled in a time-division multiplexing manner, so that the dual-frequency microstrip patch antennas operate in two modes, namely, RF energy harvesting and wireless communication. The four dual-frequency microstrip patch antennas orthogonally arranged in the X and Y directions provide good omnidirectional coverage capability, reduce dependence on the incident direction, and improve the stability of RF energy harvesting and wireless communication. This design improves the versatility and system integration of the device, simplifies the circuit structure, reduces the system complexity, and achieves self-powered operation of the wireless sensing nodes.
5. The present disclosure combines RF energy harvesting, wireless sensing, and communication technologies to achieve self-powered operation of wireless sensing nodes in the IoT environment. The realization of the antenna sensing function does not depend on an expensive vector network analyzer in the traditional technology; instead, monitoring and sensing of physical quantities in the environment are achieved by monitoring the rectification efficiency of the rectifier circuit based on the RF energy harvesting technology, which greatly reduces the cost and complexity of the sensing system. In addition, the device adopts a time-division multiplexing control mode, which can switch between RF energy harvesting and wireless communication, and flexibly allocate energy flow through an RF switch and a power divider, thereby achieving efficient energy management and communication functions. The present disclosure requires no external power supply, has the advantages of miniaturization, low power consumption, long service life, and high integration, and is particularly suitable for the IoT fields such as smart homes and smart factories, providing an integrated solution for self-powered wireless sensing and communication.

### BRIEF DESCRIPTION OF THE DRAWINGS

FIG. 1 is a schematic diagram of an overall external structure of a self-powered wireless sensing and communication device according to the present disclosure;

FIG. 2 is an exploded schematic structural diagram of a self-powered wireless sensing and communication device according to the present disclosure;

FIG. 3 is an exploded schematic structural diagram of a dual-frequency microstrip patch antenna;

FIG. 4 is an exploded schematic structural diagram of a double-layer microstrip patch antenna;

FIG. 5 is schematic diagram of an assembly structure of an antenna support frame and a double-layer microstrip patch antenna; and

FIG. 6 is a block diagram of a working principle of a self-powered wireless sensing and communication device according to the present disclosure.

Reference numerals: 1—First dielectric substrate, 2—Radiation patch, 3—First coaxial feed through—hole, 4—Parasitic patch, 5—Second dielectric substrate, 6—Main radiation patch, 7—Third dielectric substrate, 8—Second metal ground layer, 9—Second coaxial feed through-hole, 10—Support column, 11—Bottom plate, 12—Transition circuit, 13—RF switch, 14—RF rectifier circuit, 15—Control module, 16—Energy storage device, 17—SMA connector, 18—First metal ground layer.

### DETAILED DESCRIPTION OF THE EMBODIMENTS

The technical solutions of the embodiments of the present disclosure are clearly and completely described below with reference to the drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

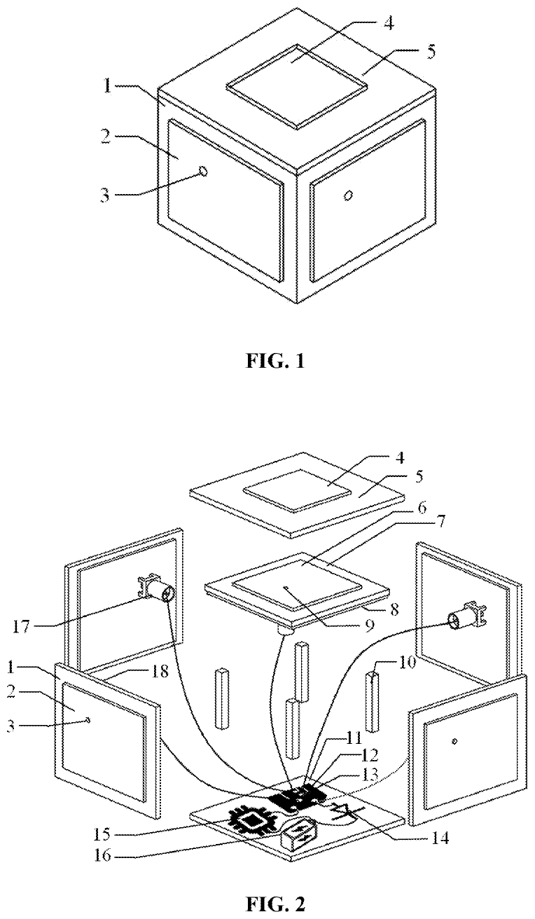

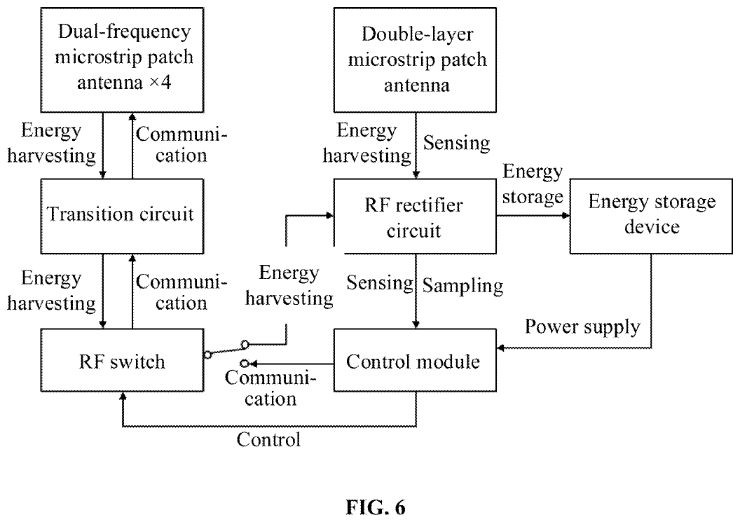

As shown in FIG. 1, FIG. 2, and FIG. 6, this embodiment provides a self-powered wireless sensing and communication device based on RF energy harvesting. The self-powered wireless sensing and communication device includes a housing, dual-frequency microstrip patch antennas, a double-layer microstrip patch antenna, an antenna support frame, a transition circuit 12, an RF switch 13, an RF rectifier circuit 14, an energy storage device 16, and a control module 15.

The housing is a hollow cubic structure. The housing is not only used for supporting and protecting internal electronic components, but also serves as a dielectric substrate of the antennas, and the specific dimensions are optimized according to application requirements. The transition circuit 12, the RF switch 13, the RF rectifier circuit 14, the energy storage device 16, and the control module 15 are all installed in the housing. The housing may be composed of the double-layer microstrip patch antenna forming a top surface, the dual-frequency microstrip patch antennas forming four side surfaces, and the antenna support frame forming a bottom surface, or may be composed of a cubic frame. When composed of a cubic frame, the double-layer microstrip patch antenna is embedded in the top of the frame, the dual-frequency microstrip patch antennas are embedded in the four sides of the frame, and the antenna support frame is slidably embedded in the bottom in a vertical direction. In this embodiment, description is made by taking an example in which the top surface of the housing is formed by the double-layer microstrip patch antenna, the four side surfaces of the housing are formed by four dual-frequency microstrip patch antennas, and the bottom surface of the housing is formed by a bottom plate 11 of the antenna support frame. The four dual-frequency microstrip patch antennas are separately fixed on the four side surfaces of the housing in orthogonal X and Y directions, and the four dual-frequency microstrip patch antennas adopt the same structure and design. Both the dual-frequency microstrip patch antennas and the double-layer microstrip patch antenna adopt a coaxial feeding manner, and both use SMA connectors 17 of the same specification. The total number of the SMA connectors 17 is five.

The double-layer microstrip patch antenna includes an upper-layer antenna and a lower-layer antenna. The upper-layer antenna is located on the top of the lower-layer antenna. The upper-layer antenna and the lower-layer antenna are completely separated and have an air gap of a predetermined height, and are configured to achieve functions of RF energy harvesting and sensing. The upper-layer antenna forms the top surface of the housing.

The four side surfaces of the housing are all formed by the dual-frequency microstrip patch antennas, and are fixedly connected to a periphery of the upper-layer antenna. The dual-frequency microstrip patch antennas are configured to achieve functions of RF energy harvesting and wireless communication. The lower-layer antenna and the dual-frequency microstrip patch antennas are all coaxially fed using a back-feeding method, and are connected to the RF rectifier circuit 14. The antenna support frame forms the bottom surface of the housing, and is slidably constrained between the four side surfaces of the housing in a vertical direction, for supporting the lower-layer antenna and adjusting the height of the air gap.

The transition circuit 12, the RF switch 13, the RF rectifier circuit 14, the energy storage device 16, and the control module 15 are all located in the housing and fixedly installed on the bottom surface of the housing, that is, fixedly installed on the top surface of the bottom plate 11. The transition circuit 12 is configured to integrate RF energy harvested by the double-layer microstrip patch antenna and the dual-frequency microstrip patch antennas into the RF rectifier circuit 14. The RF rectifier circuit 14 is configured to convert the RF energy into direct current. The RF rectifier circuit 14 includes an impedance matching circuit and a voltage multiplier rectifier circuit, both of which are implemented in a microstrip transmission mode. The impedance matching part achieves conjugate matching of input and output impedances, so as to reduce loss of RF power; the rectifier part adopts a voltage multiplier rectifier circuit structure, so as to increase output voltage and be suitable for low-power input conditions. In the process of designing the RF rectifier circuit 14, a circuit topology suitable for different input powers can be designed for different application scenarios, and Schottky diodes with low forward voltage drop and high efficiency can be selected, such as SMS7630 series, and HSMS286x series. Preferably, a filter circuit may be provided behind the RF rectifier circuit 14 for smoothing the rectified direct current output, reducing ripples, and providing a stable direct current power supply for the subsequent energy storage device 16.

The energy storage device 16 is configured to store direct current electric energy converted by the RF rectifier circuit 14, and supply the electric energy to the control module 15 to achieve self-powered operation. The energy storage device 16 may adopt a supercapacitor.

The control module 15 controls the RF switch 13 to achieve function switching of the dual-frequency microstrip patch antennas, so as to achieve RF energy harvesting and wireless communication in different time periods. The RF switch 13 needs to cover the operating frequency range of the dual-frequency microstrip patch antennas, and since the RF energy harvesting system is sensitive to power loss, a device with small insertion loss should be selected, and high isolation between signal paths should be ensured to ensure that the energy harvesting mode and the communication mode do not affect each other. The RF switch 13 may be selected from field-effect transistor (FET) switches (metal-oxide-semiconductor field-effect transistor (MOSFET) or pseudomorphic high electron mobility transistor (pHEMT)), such as models SKY13350-385LF (0.3 dB insertion loss, 37 dB isolation), HMC544 A (0.6 dB insertion loss, 34 dB isolation, suitable for DC- 8 GHz) or Peregrine PE4259 (0.4 dB insertion loss, 42 dB isolation, low-power complementary metal-oxide-semiconductor (CMOS) process).

The control module 15 samples a direct current output voltage of the RF rectifier circuit 14, calculates rectification efficiency, and transmits information to the dual-frequency microstrip patch antennas after data encoding. The control module 15 controls the RF switch 13 in a time-division multiplexing manner to switch between the two functions of RF energy harvesting and wireless communication. In the process of encoding and modulating data and realizing wireless transmission, the control module 15 may adopt a modulation mode of Frequency Shift Keying (FSK) or Quadrature Phase Shift Keying (QPSK). The control module 15 may use a low-power microcontroller unit (MCU) (such as STM32L431) or a dedicated low-power RF chip (such as nRF24L01 or CC2500).

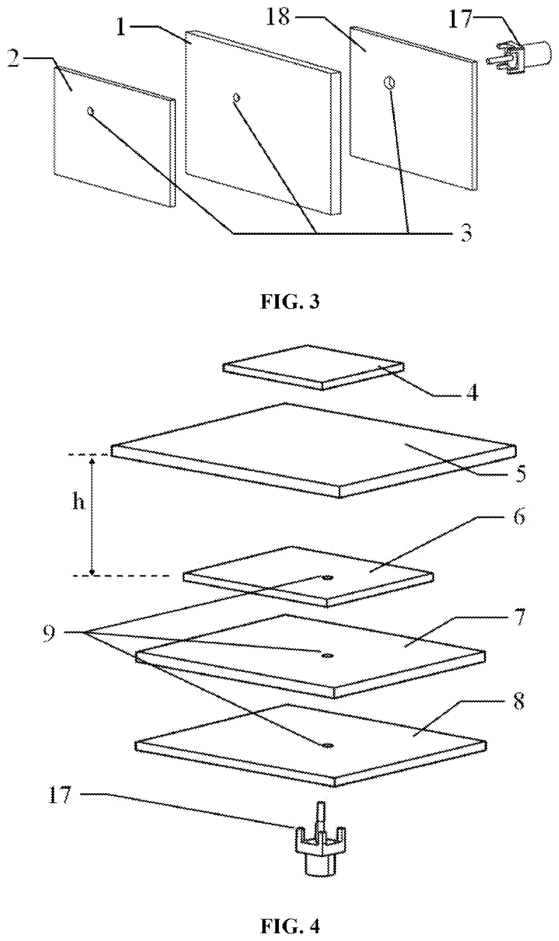

As shown in FIG. 3, the dual-frequency microstrip patch antenna includes a radiation patch 2, a first dielectric substrate 1, a first metal ground layer 18, and a first coaxial probe feed structure. The radiation patch 2 is formed on an outer side surface of the first dielectric substrate 1 in a rectangular arrangement, with the length and width generally satisfying half-wavelength resonance. The first metal ground layer 18 is formed on an inner side surface of the first dielectric substrate 1. The first coaxial probe feed structure is composed of an SMA connector 17 welded into first coaxial feed through-holes 3 of the radiation patch 2, the first metal ground layer 18, and the first dielectric substrate 1, and is configured to achieve resonance in different frequency bands, so that the dual-frequency microstrip patch antenna operates in dual frequency bands. Both the radiation patch 2 and the first metal ground layer 18 may be formed on the first dielectric substrate 1 by depositing metallic copper through a printed circuit board (PCB) process, and feed points are selected at appropriate positions according to frequency band requirements and an impedance value of 50Ω, so as to achieve a dual-band operating mode of the antenna, enabling the antenna to harvest RF energy of different frequency bands and improving the harvesting efficiency of RF energy. The radiation patch 2 is subjected to anti-oxidation treatment by tin plating. An inner surface of the first metal ground layer 18 is provided with a solder mask for increasing isolation, so as to prevent the first metal ground layer 18 from affecting the electrical performance of the internal circuit of the housing. Both the radiation patch 2 and the first metal ground layer 18 are rectangular, and the length and width of the radiation patch 2 are smaller than those of the first dielectric substrate 1 respectively. The first metal ground layer 18 covers the entire inner side surface of the first dielectric substrate 1. The first dielectric substrate 1 is made of a high-strength insulating material. After the dual-frequency microstrip patch antenna is fabricated, the first coaxial feed through-hole 3 is drilled at the selected feed point, and the SMA connector 17 is used for welding, thereby completing the fabrication of the dual-frequency microstrip patch antenna.

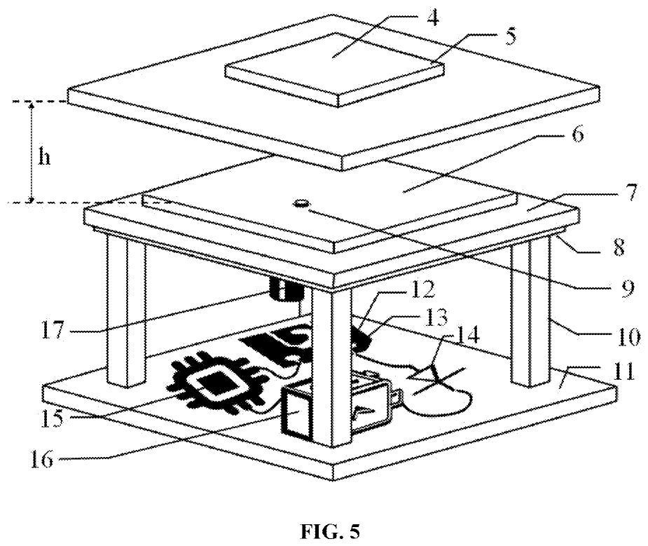

As shown in FIG. 2, FIG. 4, and FIG. 5, the upper-layer antenna is a parasitic patch 4 antenna; the lower-layer antenna is a main patch antenna; the parasitic patch 4 antenna is fed by electromagnetic coupling. The parasitic patch 4 antenna includes a second dielectric substrate 5 and a parasitic patch 4 formed on a top surface of the second dielectric substrate 5. The parasitic patch 4 serves as a parasitic coupling unit to increase the bandwidth of the antenna and improve the overall radiation efficiency of the antenna through electromagnetic coupling. The parasitic patch 4 is rectangular or circular, and a rectangular shape is taken as an example for description in this embodiment. The main patch antenna includes a main radiation patch 6, a third dielectric substrate 7, a second metal ground layer 8, and a second coaxial probe feed structure. The main radiation patch 6 is formed on a top surface of the third dielectric substrate 7, and the second metal ground layer 8 is formed on a bottom surface of the third dielectric substrate 7. The main radiation patch 6, the third dielectric substrate 7, and the second metal ground layer 8 are provided with corresponding second coaxial feed through-holes 9, and the second coaxial probe feed structure is fixedly mounted on the main radiation patch 6, the third dielectric substrate 7, and the second metal ground layer 8 through the second coaxial feed through-holes 9. After the main patch antenna is electromagnetically excited, an induced electromagnetic field excites a surface current to generate resonance. The fabrication process of the main patch antenna is similar to that of the dual-frequency microstrip patch antenna, and a PCB process is also adopted. The size of the main radiation patch 6 and the positions of the second coaxial feed through-holes 9 are related to the operating frequency band of the double-layer microstrip patch antenna. The lower-layer main patch antenna is bonded to four antenna support columns 10 and supported by the antenna support frame. The parasitic patch 4 of the upper-layer antenna is slightly smaller than the main radiation patch 6 of the lower-layer antenna, and the second dielectric substrate 5 of the upper-layer antenna may be made of the same material as the housing. The parasitic patch 4 antenna of the upper-layer antenna is suspended above the main patch antenna of the lower-layer antenna, an air gap with a height h is formed therebetween, and RF power transmission is achieved between the upper-layer and lower-layer antennas through electromagnetic coupling.

When the double-layer microstrip patch antenna is used as a sensor, a change in a physical quantity in the environment (such as pressure, stress-strain, or vibration displacement) cause a change in the height h of the air gap. This variation in the air gap alters the resonant frequency of the antenna. At this time, if the power of the ambient RF energy remains constant, the RF energy received by the double-layer microstrip patch antenna will be reduced, leading to a reduction in the rectification efficiency of the subsequent RF rectifier circuit 14. By monitoring the change in the rectification efficiency, the control module 15 monitors changes in physical quantities in the external environment, thereby enabling the antenna to function as a sensor to monitor physical quantities in the environment.

As shown in FIG. 2 and FIG. 5, the antenna support frame is composed of a bottom plate 11 and four support columns 10, and is made of a smooth and insulating material with a low dielectric constant, such as polytetrafluoroethylene (for example, Teflon®). The bottom plate 11 forms a bottom surface of the housing and is slidably constrained between the four dual-frequency microstrip patch antennas in a vertical direction. Each support column 10 has a bottom end fixedly mounted on a top surface of the bottom plate 11, and a top end supported on a bottom surface of the lower-layer antenna. The four support columns 10 are vertically fixed on the upper surface of the bottom plate 11, while ensuring certain mechanical stability. The antenna support frame and the lower-layer antenna can slide synchronously and smoothly, so as to change the height h of the air gap and achieve the sensing function.

The above-mentioned transition circuit 12 is a 4:1 Wilkinson power divider connected by equal-length coaxial lines, and based on the quarter-wavelength impedance transformation principle, has four first input ports with equal power and one first output port. An output terminal of the transition circuit is designed to a standard impedance of 50Ω to achieve low-loss transmission of RF power. The four first input ports are respectively connected to the dual-frequency microstrip patch antennas for integrating RF energy harvested by different antennas. The first output port is connected to the RF switch 13. The RF switch 13 has one second input port and two second output ports. The second input port is connected to the output terminal of the transition circuit 12, one of the second output ports is connected to the RF rectifier circuit 14, and the other second output port is connected to the control module 15.

The first dielectric substrate 1, the second dielectric substrate 5, the third dielectric substrate 7, and the bottom plate 11 are all made of low-loss dielectric materials to ensure high-efficiency electromagnetic performance when used as antenna substrates, and have sufficient mechanical strength to protect internal circuits, or may be made of high-strength insulating materials. The dielectric substrates forming the housing and the bottom plate 11 can both be made of FR 4 material (dielectric constant 4.4, loss tangent 0.02) or high-frequency plates of Rogers series, such as RO4350B (dielectric constant 3.48, loss tangent 0.0037), RT5880 (dielectric constant 2.2, loss tangent 0.0009).

The above self-powered wireless sensing and communication device can simultaneously achieve RF energy harvesting and wireless communication functions. The RF switch 13 is arranged between the transition circuit 12 and the RF rectifier circuit 14, and the control module 15 controls the RF switch 13 in a time-division multiplexing manner to ensure that RF energy harvesting and data transmission are performed alternately to avoid mutual interference. As shown in FIG. 6, the RF switch 13 operates in the energy harvesting mode most of the time; when changes in environmental physical quantities cause changes in the rectification efficiency of the RF rectifier circuit 14, the control module 15 samples the direct current output voltage of the RF rectifier circuit 14, encodes and modulates the data, and controls the RF switch 13 to switch to the communication mode, so as to transmit the processed digital signal to the dual-frequency microstrip patch antennas for sending out, thereby realizing the wireless communication function.

It will be apparent to those skilled in the art that various modifications and variations can be made to the embodiments of the present disclosure without departing from the spirit and scope of the present disclosure. Thus, provided that these modifications and variations of the present disclosure fall within the scope of the claims of the present disclosure and their equivalents, the present disclosure will also be intended to include these modifications and variations.

What is claimed is:

1. A self-powered wireless sensing and communication device based on radio frequency energy harvesting, comprising a housing, dual-frequency microstrip patch antennas, a double-layer microstrip patch antenna, an antenna support frame, a transition circuit, a radio frequency switch, a radio frequency rectifier circuit, an energy storage device, and a control module;
wherein the housing is a hollow cubic structure; the double-layer microstrip patch antenna comprises an upper-layer antenna and a lower-layer antenna, and the upper-layer antenna and the lower-layer antenna are completely separated, have an air gap, and are configured to achieve functions of radio frequency energy harvesting and sensing; the upper-layer antenna is a parasitic patch antenna; the lower-layer antenna is a main patch antenna; the parasitic patch antenna is fed by electromagnetic coupling; the upper-layer antenna forms a top surface of the housing; the lower-layer antenna is supported at a bottom end of the upper-layer antenna through the antenna support frame; four side surfaces of the housing are all formed by the dual-frequency microstrip patch antennas and are fixedly connected to a periphery of the upper-layer antenna; the antenna support frame forms a bottom surface of the housing and is slidably constrained between the four side surfaces of the housing in a vertical direction for adjusting a height of the air gap; the dual-frequency microstrip patch antennas are configured to achieve functions of radio frequency energy harvesting and wireless communication; the lower-layer antenna and the dual-frequency microstrip patch antennas are all coaxially fed using a back-feeding method and are connected to the radio frequency rectifier circuit; and
the transition circuit, the radio frequency switch, the radio frequency rectifier circuit, the energy storage device, and the control module are all located inside the housing and are fixedly installed on the antenna support frame; the transition circuit is configured to integrate radio frequency energy harvested by the double-layer microstrip patch antenna and the dual-frequency microstrip patch antennas to the radio frequency rectifier circuit; the radio frequency rectifier circuit is configured to convert the radio frequency energy into direct current; the energy storage device is configured to store electrical energy converted by the radio frequency rectifier circuit and supply the electrical energy to the control module to achieve self-powered operation; and the control module is configured to control the radio frequency switch to achieve function switching of the dual-frequency microstrip patch antennas, enabling the radio frequency energy harvesting and the wireless communication in different time periods.

2. The self-powered wireless sensing and communication device according to claim 1, wherein the dual-frequency microstrip patch antennas each comprise a radiation patch, a first dielectric substrate, a first metal ground layer, and a first coaxial probe feed structure; the radiation patch is formed on an outer side surface of the first dielectric substrate; the first metal ground layer is formed on an inner side surface of the first dielectric substrate; the first coaxial probe feed structure is formed by a SubMiniature version A (SMA) connector welded to first coaxial feed through-holes of the radiation patch, the first metal ground layer, and the first dielectric substrate, and the first coaxial probe feed structure is configured to achieve resonance in different frequency bands, such that the dual-frequency microstrip patch antennas operate in dual frequency bands.

3. The self-powered wireless sensing and communication device according to claim 2, wherein the radiation patch and the first metal ground layer are formed on the first dielectric substrate by deposition using metallic copper; the radiation patch is subjected to anti-oxidation treatment by tin plating; a solder mask layer for increasing isolation is provided on an inner surface of the first metal ground layer; the radiation patch and the first metal ground layer are rectangular, and a length and a width of the radiation patch are smaller than a length and a width of the first dielectric substrate respectively; the first metal ground layer covers the inner side surface of the first dielectric substrate; and the first dielectric substrate is made of a high-strength insulating material.

4. The self-powered wireless sensing and communication device according to claim 1, wherein the parasitic patch antenna comprises a second dielectric substrate and a parasitic patch formed on a top surface of the second dielectric substrate; and
the parasitic patch serves as a parasitic coupling unit to increase a bandwidth of the antenna through the electromagnetic coupling and improve overall radiation efficiency of the parasitic patch antenna; and the parasitic patch is rectangular or circular.

5. The self-powered wireless sensing and communication device according to claim 1, wherein the main patch antenna comprises a main radiation patch, a third dielectric substrate, a second metal ground layer, and a second coaxial probe feed structure, wherein
the main radiation patch is formed on a top surface of the third dielectric substrate;
the second metal ground layer is formed on a bottom surface of the third dielectric substrate;
the second coaxial probe feed structure is fixedly installed on the main radiation patch, the third dielectric substrate, and the second metal ground layer; and
after the main patch antenna is electromagnetically excited, an induced electromagnetic field excites a surface current to generate resonance.

6. The self-powered wireless sensing and communication device according to claim 1, wherein when the double-layer microstrip patch antenna is used as a sensor, a change in a physical quantity in an environment causes a change in the height of the air gap and a change in an antenna resonant frequency, leading to a change in efficiency of the radio frequency rectifier circuit, and enabling monitoring of the physical quantity in the environment.

7. The self-powered wireless sensing and communication device according to claim 1, wherein the antenna support frame comprises a bottom plate and four support columns, and the antenna support frame is made of a smooth and insulating material with a low dielectric constant; the bottom plate forms the bottom surface of the housing, and the bottom plate is slidably constrained between four dual-frequency microstrip patch antennas in the vertical direction; and each of the four support columns has a bottom end fixedly installed on a top surface of the bottom plate, and a top end supported on a bottom surface of the lower-layer antenna.

8. The self-powered wireless sensing and communication device according to claim 1, wherein the transition circuit is a 4:1 power divider connected by equal-length coaxial lines, and the transition circuit has four first input ports and one first output port; the four first input ports are respectively connected to the dual-frequency microstrip patch antennas, and four first output ports are connected to the radio frequency switch; and
the radio frequency switch has one second input port and two second output ports; the second input port is connected to an output terminal of the transition circuit, one of the two second output ports is connected to the radio frequency rectifier circuit, and the other of the two second output ports is connected to the control module.

9. The self-powered wireless sensing and communication device according to claim 8, wherein the radio frequency rectifier circuit comprises an impedance matching circuit and a voltage multiplier rectifier circuit,
the energy storage device is a supercapacitor;
the control module samples a direct current output voltage of the radio frequency rectifier circuit, calculates rectification efficiency, and transmits information to the dual-frequency microstrip patch antennas after data encoding; and
the control module controls the radio frequency switch in a time-division multiplexing manner, to switch between the radio frequency energy harvesting and the wireless communication.

10. The self-powered wireless sensing and communication device according to claim 2, wherein the antenna support frame comprises a bottom plate and four support columns, and the antenna support frame is made of a smooth and insulating material with a low dielectric constant; the bottom plate forms the bottom surface of the housing, and the bottom plate is slidably constrained between four dual-frequency microstrip patch antennas in the vertical direction; and each of the four support columns has a bottom end fixedly installed on a top surface of the bottom plate, and a top end supported on a bottom surface of the lower-layer antenna.

11. The self-powered wireless sensing and communication device according to claim 3, wherein the antenna support frame comprises a bottom plate and four support columns, and the antenna support frame is made of a smooth and insulating material with a low dielectric constant; the bottom plate forms the bottom surface of the housing, and the bottom plate is slidably constrained between four dual-frequency microstrip patch antennas in the vertical direction; and each of the four support columns has a bottom end fixedly installed on a top surface of the bottom plate, and a top end supported on a bottom surface of the lower-layer antenna.

12. The self-powered wireless sensing and communication device according to claim 4, wherein the antenna support frame comprises a bottom plate and four support columns, and the antenna support frame is made of a smooth and insulating material with a low dielectric constant; the bottom plate forms the bottom surface of the housing, and the bottom plate is slidably constrained between four dual-frequency microstrip patch antennas in the vertical direction; and each of the four support columns has a bottom end fixedly installed on a top surface of the bottom plate, and a top end supported on a bottom surface of the lower-layer antenna.

13. The self-powered wireless sensing and communication device according to claim 5, wherein the antenna support frame comprises a bottom plate and four support columns, and the antenna support frame is made of a smooth and insulating material with a low dielectric constant; the bottom plate forms the bottom surface of the housing, and the bottom plate is slidably constrained between four dual-frequency microstrip patch antennas in the vertical direction; and each of the four support columns has a bottom end fixedly installed on a top surface of the bottom plate, and a top end supported on a bottom surface of the lower-layer antenna.

14. The self-powered wireless sensing and communication device according to claim 6, wherein the antenna support frame comprises a bottom plate and four support columns, and the antenna support frame is made of a smooth and insulating material with a low dielectric constant; the bottom plate forms the bottom surface of the housing, and the bottom plate is slidably constrained between four dual-frequency microstrip patch antennas in the vertical direction; and each of the four support columns has a bottom end fixedly installed on a top surface of the bottom plate, and a top end supported on a bottom surface of the lower-layer antenna.

15. The self-powered wireless sensing and communication device according to claim 2, wherein the transition circuit is a 4:1 power divider connected by equal-length coaxial lines, and the transition circuit has four first input ports and one first output port; the four first input ports are respectively connected to the dual-frequency microstrip patch antennas, and four first output ports are connected to the radio frequency switch; and
the radio frequency switch has one second input port and two second output ports; the second input port is connected to an output terminal of the transition circuit, one of the two second output ports is connected to the radio frequency rectifier circuit, and the other of the two second output ports is connected to the control module.

16. The self-powered wireless sensing and communication device according to claim 3, wherein the transition circuit is a 4:1 power divider connected by equal-length coaxial lines, and the transition circuit has four first input ports and one first output port; the four first input ports are respectively connected to the dual-frequency microstrip patch antennas, and four first output ports are connected to the radio frequency switch; and
the radio frequency switch has one second input port and two second output ports; the second input port is connected to an output terminal of the transition circuit, one of the two second output ports is connected to the radio frequency rectifier circuit, and the other of the two second output ports is connected to the control module.

17. The self-powered wireless sensing and communication device according to claim 4, wherein the transition circuit is a 4:1 power divider connected by equal-length coaxial lines, and the transition circuit has four first input ports and one first output port; the four first input ports are respectively connected to the dual-frequency microstrip patch antennas, and four first output ports are connected to the radio frequency switch; and
the radio frequency switch has one second input port and two second output ports; the second input port is connected to an output terminal of the transition circuit, one of the two second output ports is connected to the radio frequency rectifier circuit, and the other of the two second output ports is connected to the control module.

18. The self-powered wireless sensing and communication device according to claim 5, wherein the transition circuit is a 4:1 power divider connected by equal-length coaxial lines, and the transition circuit has four first input ports and one first output port; the four first input ports are respectively connected to the dual-frequency microstrip patch antennas, and four first output ports are connected to the radio frequency switch; and
the radio frequency switch has one second input port and two second output ports; the second input port is connected to an output terminal of the transition circuit, one of the two second output ports is connected to the radio frequency rectifier circuit, and the other of the two second output ports is connected to the control module.

19. The self-powered wireless sensing and communication device according to claim 6, wherein the transition circuit is a 4:1 power divider connected by equal-length coaxial lines, and the transition circuit has four first input ports and one first output port; the four first input ports are respectively connected to the dual-frequency microstrip patch antennas, and four first output ports are connected to the radio frequency switch; and
the radio frequency switch has one second input port and two second output ports; the second input port is connected to an output terminal of the transition circuit, one of the two second output ports is connected to the radio frequency rectifier circuit, and the other of the two second output ports is connected to the control module.

20. The self-powered wireless sensing and communication device according to claim 15, wherein the radio frequency rectifier circuit comprises an impedance matching circuit and a voltage multiplier rectifier circuit,
the energy storage device is a supercapacitor;
the control module samples a direct current output voltage of the radio frequency rectifier circuit, calculates rectification efficiency, and transmits information to the dual-frequency microstrip patch antennas after data encoding; and
the control module controls the radio frequency switch in a time-division multiplexing manner, to switch between the radio frequency energy harvesting and the wireless communication.
